(19) United States
(12) Patent Application Publication
(10) Pub. No.: US 2010/0327145 A1
(43) Pub. Date: Dec. 30, 2010

(54) Brace, system and method for forming cementitious structures on a ground surface

(76) Inventor: Normand Savard, Baie-Comeau (CA)

Correspondence Address: Franz BONSANG;c/o EQUINOX PROTECTION, 410 - 1500, Du College, St-Laurent, QC, H4L 5G6, CA

(21) Appl. No.: 12/457,977

(22) Filed: Jun. 26, 2009

(51) Int. Cl. E01C 19/00; B29C 33/48

(52) U.S. Cl. 249/5; 264/219

(57) ABSTRACT

A system for forming a cementitious structure of cementitious material on a ground surface is provided. The system consists of at least one pair of moulds, each mould having at least one pathway disposed thereon, and at least one brace having two spikes connected to one another by a connecting member. The spikes are inserted into the pathways to space the moulds apart, via the connecting member, in fixed spatial relationship and then into the ground surface to anchor the moulds thereto. The cementitious material is then poured between the moulds to form the cementitious structure. Optionally, the spikes may be connected to the connecting member by inserting of spikes into tubes connected to the connecting member, the tubes being insertable into pathways and the spikes subsequently inserted therethrough to insert the spikes through the pathway and into the ground surface.

### FIELD OF THE INVENTION

The present invention is related to forming cementitious structures, and is more particularly directed to a brace, system, and method for forming cementitious structures on a ground surface.

### BACKGROUND OF THE INVENTION

Moulds and braces, and systems and methods therefor, for forming cementitious structures on ground surfaces, for example sidewalks or walkways on the ground surface, are well known in the art. Typically, such methods and systems involve at least two spaced apart moulds which are placed on the ground surface, with spacing members, for example wood blocks shown in stippled lines in FIG. 1, placed in contact with respective inner walls of the moulds. The spacing members maintain the moulds spaced apart from one another and prevent them from falling inwardly toward one another during pouring of the cementitious material to form the structure. To keep the moulds held against the spacing members, spikes are inserted or driven through each mould, at positions generally opposite one another, and into the ground surface and wire is attached to the spikes and tightened to brace and maintain the moulds tightly against the spacing members. The cementitious material is then poured between the moulds to from the structure.

Unfortunately, the forming of the cementitious structure described above presents a number of disadvantages. For example, to anchor the moulds to one another, the spikes must first be driven through the moulds and into the ground and then the wires attached while at the same time, and rather cumbersomely, maintaining the spacing members in position. Further, as the spikes must already be driven into the ground through the moulds to anchor the moulds to one another, adjusting the level of the moulds relative the ground surface and their position relative one another requires manipulation of the moulds with the spikes already inserted therethrough, which is difficult and awkward.

Accordingly, there is a need for an improved brace, system and method for forming cementitious structures on a ground surface.

### SUMMARY OF THE INVENTION

It is therefore a general object of the present invention to provide an improved brace, system and method for forming cementitious structures on a ground surface.

An advantage of the present invention is that the brace, system and method thereof allows for anchoring of moulds for forming the structure prior to placement of the moulds on the ground surface.

Another advantage of the present invention is that the brace, system and method thereof permit positioning of the moulds at a predetermined angular inclination, for example 90 degrees, prior to insertion of any spikes into the ground surface.

A further advantage of the present invention is that the height and leveling of the moulds relative the ground surface may be easily adjusted, even after the moulds are anchored together.

Still another advantage of the present invention is that the forming of the cementitious structure is achieved with relatively little manipulation of material or tools, compared to the prior art.

Still another advantage of the present invention is that the forming of the cementitious structure is achieved with relatively little effort and manpower.

According to a first aspect of the present invention, there is provided a system for forming a cementitious structure extending on a ground surface, the system comprising:
at least one pair of moulds, each mould of each pair having at least one spike pathway;
at least one brace having respective first and second spikes and a connecting member, the connecting member connecting the spikes to one another at a fixed distance relative one another, each spike being insertable through one the spike pathway on each mould of each pair to anchor the moulds of each pair in fixed spatial relationship relative one another and from the spike pathways into the ground surface to anchor the moulds in the fixed spatial relationship to the ground surface for pouring of a cementitious structure between respective inner walls of the moulds to form the cementitious structure on the ground surface.

In a second aspect of the present invention, there is provided a method for forming a cementitious structure on a ground surface, the method comprising the steps of:
anchoring at least one pair of moulds to one another in fixed spatial relationship with at least one brace having first and second spikes connected by a connecting member by snugly inserting the spikes through respective spike pathways disposed on the moulds, one spike of each brace for each mould;
for each spike inserted through the respective spike pathway, further inserting the spike into the ground surface to anchor each mould to the ground surface; and
distributing a cementitious material between each the mould anchored to the ground surface to form the cementitious structure.

In a third aspect of the present invention, there is provided a brace for use in anchoring first and second moulds to one another and a ground surface during distribution of a cementitious material between respective inner walls of the moulds to form a cementitious structure extending on the ground surface between the moulds, each mould having at least one respective spike pathway disposed thereon, the brace comprising:
respective first and second spikes;
a connecting member, the connecting member connecting the spikes to one another at a fixed distance relative one another, each spike being insertable through one the spike pathway on each mould of each pair to anchor the moulds of each pair in fixed spatial relationship relative one another and from the spike pathways into the ground surface to anchor the moulds in the fixed spatial relationship to the ground surface for pouring of the cementitious material.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a top perspective view of an embodiment of a system for forming a cementitious structure on a ground surface in accordance with the present invention;

FIG. 1a is a top perspective view of the system shown in FIG. 1, showing an alternative pathway for braces sued with the system;

FIG. 2 is a perspective view of a brace for the system shown in FIG. 1;

FIG. 3 is a perspective view of an alternative brace for the system shown in FIG. 1; and

FIG. 4 is a perspective view of another alternative brace for the system shown in FIG. 1.

### DETAILED DESCRIPTION OF THE PREFERRED EMBODIMENTS

With reference to the annexed drawings the preferred embodiments of the present invention will be herein described for indicative purpose and by no means as of limitation.

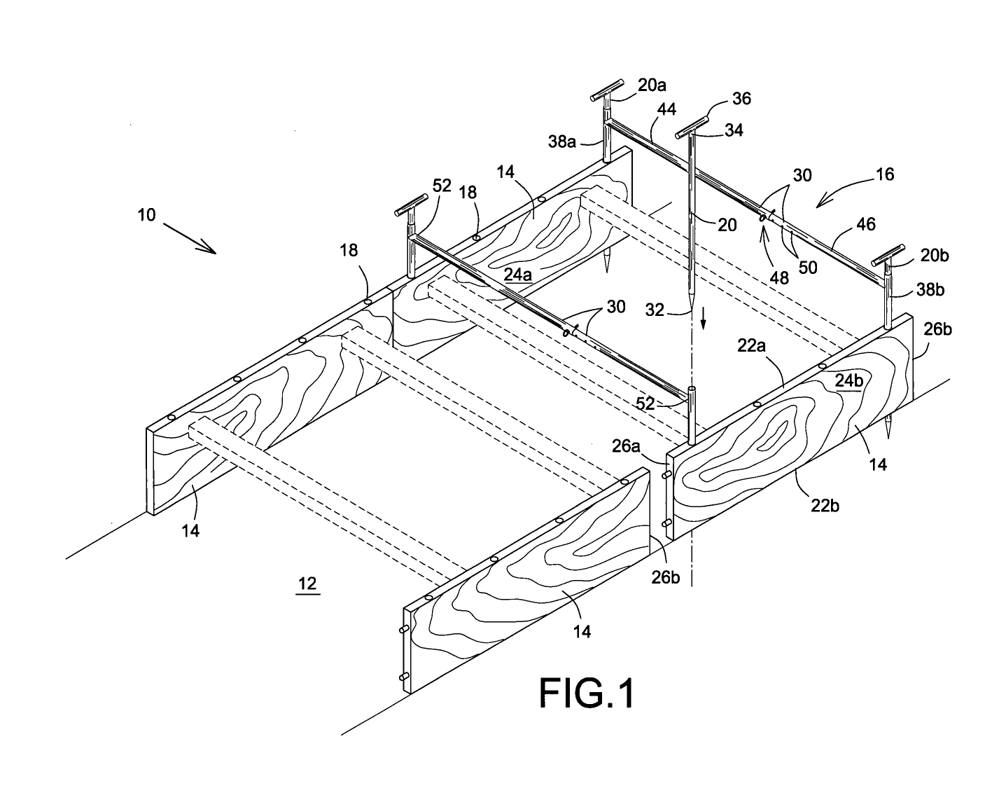

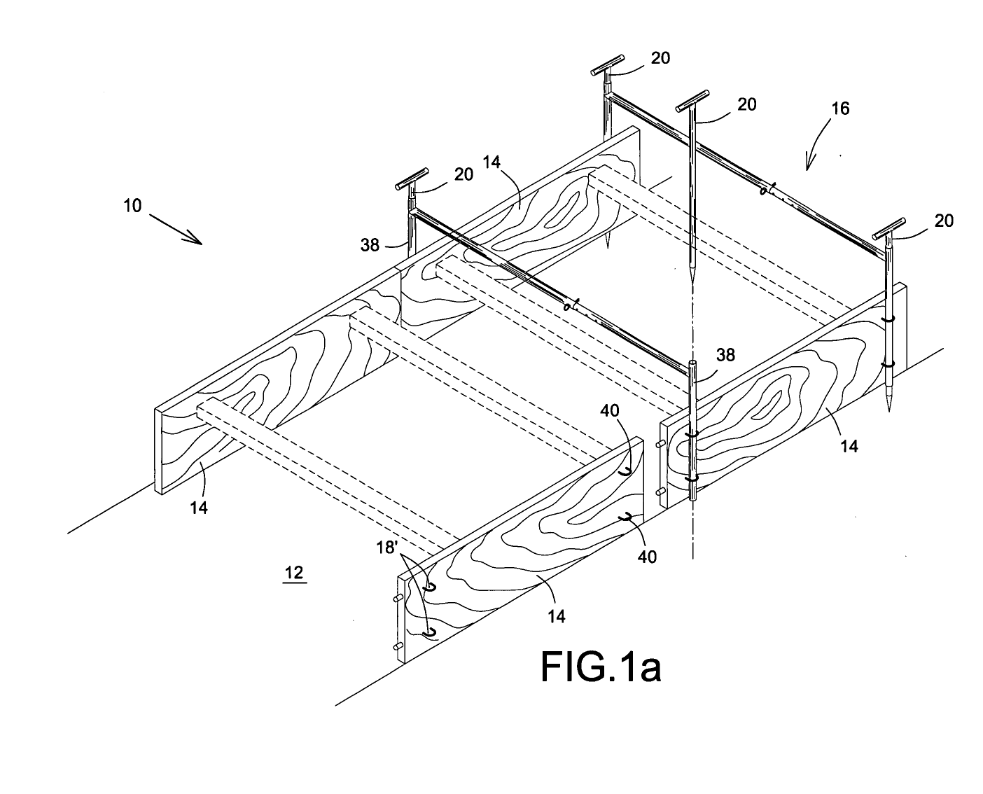

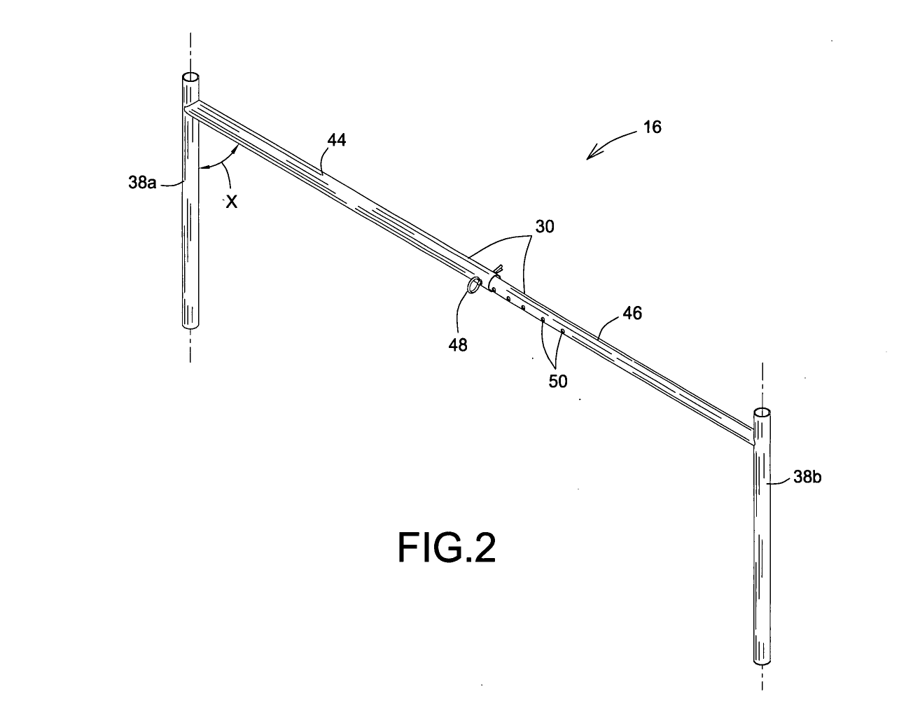

Referring to FIGS. 1 and 2, there is shown an embodiment of a system, shown generally as 10, for forming a cementitious structure, not shown, on a ground surface 12 in accordance with an embodiment of the present invention. The cementitious structure may be any cementitious structure which is typically formed over a ground surface 12, for example, a sidewalk, road curb, walkway, or the like.

Generally speaking, and as shown in FIGS. 1, 1a, and 2, the system 10 includes at least one pair of moulds 14 and, for each pair of moulds, at least one brace, shown generally as 16. Each mould 14 of each pair has at least one respective brace pathway 18, 18′ defining a pathway from a top side 22a to a bottom side 22b of the mould 14, and between which an inner and outer wall 24a, 24b of the mould 14 extend. However, preferably, and as shown, each mould 14 has at least two spaced apart brace pathways 18, 18′, with at least one pathway 18, 18′ disposed proximal each mould end 26a, 26b of the mould 14. Preferably, the moulds 14 of each pair are identical with the pathways 18, 18′ on each mould 14 being aligned with one another at identical positions relative the mould ends 26 of the moulds.

Each brace 16 has first and second spikes 20 and a connecting member 30 by which the spikes 20 are connected to one another at member ends 52 of the connecting member 30, at a predetermined fixed distance relative one another. The spikes 20 and pathways 18, 18′ are sized and shaped such that the spikes 20 are snugly insertable into the pathways 18, 18′ one spike 20 in a pathway of each mould 14 of each pair, such that each spike 20 extends from the top side 22a through the bottom side 22b of the mould 14 immobilized in the pathway 18, 18′. Thus, when the spikes 20, connected by the connecting member 30, are inserted into the pathways 18, 18′ the moulds 14 are maintained facing one another in a fixed spatial relationship, i.e. spaced apart from one another at a predetermined distance. Thus, the braces 16 prevent the moulds 14 from falling inwardly towards one another or outwardly away from one another. By further insertion of the spikes 20 into the ground surface 12, the moulds 14 in the fixed spatial relationship are fixable, i.e. anchored, to the ground surface 12, with the bottoms sides 22b thereof proximal or abutting the ground surface 12. The cementitious material may then be poured between the moulds 14, specifically the inner walls 24a, to form the cementitious structure on the ground surface 12.

The spikes 20 are made of a sturdy, rigid material, such as a metal or the like and have generally pointed spike ends 32 situated longitudinally opposite top ends 34 thereof. The top ends 34, which may have optional cross bars 36 disposed thereon, are disposed proximal the connecting member 30, and the pointed end 32 disposed distal thereto. Thus, it is the pointed end 32 that is initially inserted into the spike pathway 18, 18′ from the top side 22a through the bottom side 22b, the top end 34 and the pointed end 32 being disposed, respectively, proximal the top side 22a and bottom side 22b. Thus, the pointed end 32 can be subsequently inserted, for example forcibly driven, into the ground surface 12.

As shown for the brace 16 in FIGS. 1 and 2, the brace 16 may have hollow pathway tubes 38 connected to the connecting member 30 at member ends 52. The spikes 20 and pathway tubes 38 are sized and shaped such that each spike 20 is snugly and removably insertable into a pathway tube 38 to removably connect the spikes 20 to the connecting member 30. For such a brace 16, the pathway tubes 38 and the pathways 18 are sized and shaped such that the pathway tubes 38 are snugly insertable into the pathways 18, 18′ with the spikes 20 snugly inserted into and through the tubes 38 to snugly insert the spikes 20 through the pathways 18, 18′. The first and second tubes 38, and thereby the spikes 20 when inserted therein, are connected to the connecting member 30 at a respective predetermined angular inclination, shown as X, relative thereto. Thus, the first and second pathway tubes 38, when inserted into the pathways 18, 18′ respectively anchor the first and second moulds 14 relative the connecting member 30 at the respective predetermined angular inclination X, preferably 90 degrees.

Referring still to FIGS. 1 and 2, the length of the connecting member 30 may be adjustable to adjust the distance between the tubes 38 and spikes 20, and thereby the spatial relationship, i.e. the spacing, between the moulds 14. More specifically, the connecting member 30 consists of a first portion 44 and a second portion 46. The first portion 44 is connected to one tube 38a, and thereby the spike 20a when inserted into tube 38a. The second portion 46 is connected to the other tube 38b, and thereby to spike 20b when inserted into tube 38b. The second portion 46 is slidably inserted into an open end of the first portion 44. Thus, the portions 44, 46 are slidably and telescopically movable relative one another relative one another, enabling slidable and telescopic retraction and extension of the connecting member 30 and adjustment of the length thereof. A locking means, shown generally as 48, is engageable to releasably and lockingly immobilize the portions 44, 46 relative one another, and therefore to lock the connecting member 30 at a desired length. For example, the first and second portions 44, 46 could each have, as shown, at least one, and preferably more than one, pair of axially aligned through holes 50. By sliding the portions 44, 46 relative one another, pairs of through holes 50 on each portion 44, 46 may be aligned with one another at a desired length for the connecting member 50. The locking means 48, for example a locking pin or bolt, could then be inserted into the axially aligned pairs of holes 50 of the portions 44, 46 to immobilize the portions 44, 46 and set the length of the connecting member 30, and thereby the distance between the tubes 38 and spikes 20. For subsequent readjustment, the locking means 48 may be removed and the portions 44, 46 slidably re-positioned in similar fashion with different pairs of through holes 50 on each portion 44, 46 aligned with one another.

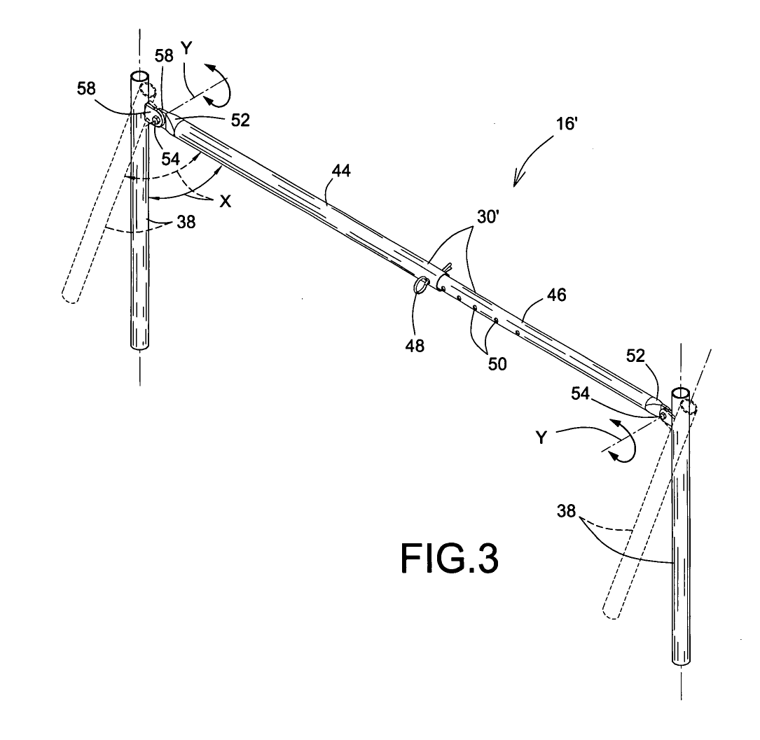

Referring now to FIG. 3, therein is shown an alternative brace 16′ for use with the system 10. The brace 16′ is identical to the brace 16 shown in FIG. 1, with the exception of the connecting member 30′ therefor and its connection to tubes 38. More specifically, at least one of, and preferably both, the first and second pathway tubes 38 are connected to the connecting member 30 at respective member ends 52 thereof by a respective adjustable lockable connector, shown generally as 54, defining a rotation axis Y for each tube 38.

The lockable connector 54 has an unlocked configuration, in which the tube 38 is rotatable around the rotation axis Y to adjust the angular inclination X of the tube 38, and the spike 20 placed therein. In this fashion, the angular inclination of the tubes 38 and spikes 20, as well as the moulds 14 relative the connecting member 30′ may be adjusted. In a locked configuration, the connector 54 immobilizes the tube 38, and the spike inserted therein 20, against the member end 52, and thus locks the tube 38 in the angular inclination X. For example, and as shown, the lockable connector 54 may be a bolt 54 which defines the rotation axis Y engaged in plates 58 connected to the tubes 38, one for each tube 38, and member ends 52, one for each member end 52. By loosening the bolt 54 connecting the plates 58 at a member end 52, the plates 58, and thereby the tube 38 and connecting member 30′, may be rotated relative one another into a desired angular inclination X. The bolt 54 may then be tightened to immobilize the plates 58 against one another, thus immobilizing the connecting member 30′ and tube 38, as well as the spike 20 inserted therein, in the desired angular inclination X.

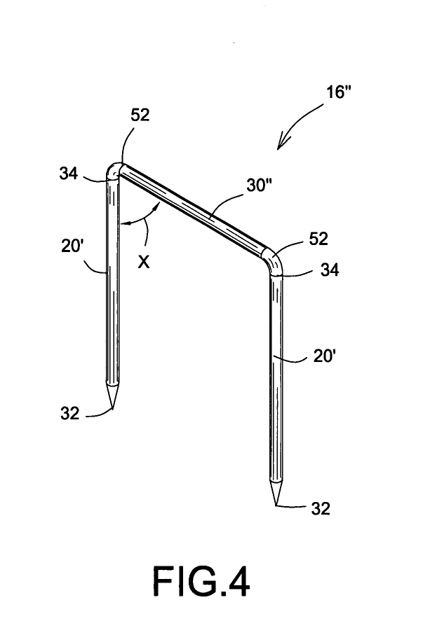

Referring now to FIG. 4, therein is shown another alternative brace 16″ for use with the system 10. For the brace 16″ shown, the pathway tubes 38 are absent. Instead, the spikes 20′ are directly connected to the connecting member 30″ at member ends 52′. Accordingly, the spikes 52′ are directly snugly inserted into the pathways 18, 18′ of moulds 14. Further, connecting member 30″ is a preferably a unitary structure, without slidable first and second portions 44, 46, locking means 48, or through holes 50. Thus, the length of the connecting member 30″, and the distance between the spikes 20′, are not adjustable. Further, the spikes 20′ are fixedly attached to the connecting member 30″. Thus, the angular inclination X, preferably 90 degrees, between the connecting member 30″ and the spikes 20′ is not adjustable. However, if desired, the connecting member 30 of brace 16 could be substituted for the connecting member 30″, and directly connected to the spikes 20′, to make the distance between the spikes 20′ adjustable. Similarly, the connecting member 30″ could be adapted to include one or more plates 58 and lockable connectors 54 to render the angular inclination adjustable, as for the brace 16′ shown in FIG. 3.

In use, and now describing a method for forming a cementitious structure on the ground surface 12, using the braces 16, 16′, 16″ and moulds 14 described above, the spikes 20, 20′ are snugly inserted, as described above, into the pathways 18 in the moulds 14 to anchor the moulds 14 to one another in fixed spatial relationship. For braces 16, 16′, the tubes 38 snugly inserted into the pathways 18, 18′ and the spikes 20 snugly inserted into the tubes 38 of the brace 16, 16′ to insert the spikes 20 through the pathways 18, 18′. For braces 16, 16′, the length of the connecting member 30, 30″ may be slidably and telescopically adjusted as described above to adjust the distance between the tubes 38, and thereby the spatial relationship between the moulds with the tubes 38 and spikes 20 inserted therein. For brace 16′, the angular inclination X between the connecting member 30′ and the tubes 38 may also be adjusted, as described above. The spikes 20, 20″ are inserted through the pathways 18 to anchor the moulds 14 to the ground surface 12. The cementitious material is then distributed between the moulds 14 to form the structure. Advantageously, the braces 16, 16, 16″ can be snugly engaged in the pathways 18, and adjustments to the length of the connecting member 30′ and angular inclination X made, prior to placement of the moulds 14 on the ground surface 12 and driving of the spikes 20, 20′ thereinto. Thus, adjustments in the spatial relationship between the moulds 14 of each pair, including the distance therebetweeen and angular inclination of each mould 14 relative the connecting member 30′, are easily made prior to anchoring the moulds 14 to the ground surface 12.

If desired, prior to inserting the spikes 20, 20′ into the ground surface 12 to anchor the moulds 14 thereto, a supporting material, not shown, may be placed between a portion of the bottom side 22b of the mould 14 and the ground surface 12 to adjust the height or leveling of the mould 14 relative the ground surface 12. Further, if desired, the supporting material may be placed lengthwise under the bottom side 22b of the mould 14 and/or alongside the outer wall 24b thereof, from one end 26a to the other 26b. The supporting material may be any material, for example earth, penetrable by the spike 20, 20′. The length of spikes 20, 20′, tubes 38, and pathway 18, 18′ are determined based on the height of the moulds 14, which is determined in function of the desired height and/or thickness of the cementitious structure relative the ground surface 12.

As shown in FIG. 1, the pathways 18 may be channels 18 extending preferably through the moulds 14, alongside the inner wall 24a of each mould 14, from the top side 22a to the bottom side 22b. However, as shown in FIG. 1a, each pathway 18′ may also be defined by one or more, preferably axially aligned, brackets 40 disposed on the outer wall 24 of the mould 42. Further, when the spikes 20, 20′ and pathways therefore are cylindrically shaped, as shown, it is preferable to have at least two braces 16, 16′, 16″ for each pair of moulds 14, each brace 16 preferably engaged in pathways 18, 18′ situated proximal a mould end 26 of the mould 14, to minimize risk of moulds 14 rotating around the spike 20, 20′. However, the spikes 20, 20′, pathway tubes 38, and pathways 18, 18′ may also have other matching shapes, for example rectangular or triangular, which prevent rotation of mould 14 therearound when the spikes 20, 20′ are engaged therein. In such case, a single brace 16, 16′, 16″ per pair of moulds 14 may be sufficient. The moulds 14 are preferably rectangular wooden blocks 14. However, the moulds 14 may also be of any other material, for example metal, plastic, or the like, suitable for forming cementitious structures. Further, the moulds 14 may be of other shapes provided that the mould 14 provides the inner wall 24 and pathways 18, 18′ as described above. The length of spikes 20, 20′, tubes 38, and pathways 18, 18′ are determined based on the height of the moulds 14, which is itself determined in function of the desired height and/or thickness of the cementitious structure relative the ground surface 12. It should be noted that, to connect different pairs of moulds 14 together, each mould 14 may have connectors 60 at one mould end 26a for connecting insertion into mould end 26b of the moulds 14 of an adjoining pair.

While a specific embodiment has been described, those skilled in the art will recognize many alterations that could be made within the spirit of the invention, which is defined solely according to the following claims.

I claim:

1. A system for forming a cementitious structure extending on a ground surface, said system comprising:
at least one pair of moulds, each mould of each pair having at least one spike pathway; and
at least one brace having respective first and second spikes and a connecting member, the connecting member connecting the spikes to one another at a fixed distance relative one another, each spike being insertable through one said spike pathway on each mould of each pair to anchor said moulds of each pair in fixed spatial relationship relative one another and from the spike pathways into the ground surface to anchor the moulds in said fixed spatial relationship to the ground surface for pouring of a cementitious structure between respective inner walls of said moulds to form the cementitious structure on the ground surface.

2. The system of claim 1, wherein each said spike pathway extends through said mould alongside said inner wall.

3. The system of claim 1, wherein said at least one spike pathway comprises a plurality of spike pathways in spaced apart relationship.

4. The system of claim 3, wherein said at least one brace comprises a plurality of braces.

5. The system of claim 1, wherein said brace further comprises first and second hollow pathway tubes connected to said connecting member, said pathway tubes being snugly insertable into said pathways and said spikes being snugly insertable through said pathway tubes to connect said spikes to said connecting member and snugly insert said spikes through said pathways and into said ground surface.

6. The system of claim 5, wherein said first and second pathway tubes are each connected to said connecting member at a respective predetermined angular inclination relative thereto, said first and second pathway tubes inserted into said spike pathways thereby respectively anchoring said first and second moulds relative the connecting member at said respective predetermined angular inclination.

7. The system of claim 6, wherein said respective predetermined angular inclination is adjustable.

8. The system of claim 6, wherein said respective predetermined angular inclination is 90 degrees.

9. The system of claim 6, wherein at least one of said first and second pathway tubes are connected to the connecting member at a respective member end thereof by a respective lockable connector defining a rotation axis for each pathway tube and around which said pathway tube and said connector member is rotatable to adjust said respective predetermined angular inclination, said lockable connector being lockable to immobilize said tube against said end at said respective predetermined angular inclination.

10. The system of claim 1, wherein said connecting member is adjustable in length, said fixed spatial relationship being thereby adjustable.

11. The system of claim 10, wherein said connecting member comprises a first portion connected to said first spike and second portion connected to said second spike, said second portions being slidably inserted into and connected to said first portion and slidably movable relative thereto to slidably adjust said length, said brace further comprising a locking means for immobilizing said first and said second portions relative one another.

12. The system of claim 11, wherein said first and second portions each have at least one respective pair of axially aligned through holes, said respective pairs of axially aligned through holes being axially alignable with one another by sliding said first and second portions relative one another, said locking means being insertable through said pairs in axial alignment with one another to lock said first and second portion together to adjust said length.

13. A method for forming a cementitious structure on a ground surface, said method comprising the steps of:
anchoring at least one pair of moulds to one another in fixed spatial relationship with at least one brace having first and second spikes connected by a connecting member by snugly inserting said spikes through respective spike pathways disposed on said moulds, one spike of each brace for each mould;
for each spike inserted through said respective spike pathway, further inserting said spike into said ground surface to anchor each mould to the ground surface; and
distributing a cementitious material between each said mould anchored to said ground surface to form said cementitious structure.

14. The method of claim 13, wherein said step of anchoring at least one pair of moulds comprises the steps of:
snugly inserting said first and second spikes through, respectively, first and second pathway tubes connected to said connecting member; and
snugly inserting each of said first and second pathway tubes into said spike pathways.

15. The method of claim 13, further comprising the step of, prior to said step of further inserting said spike into said ground surface:
adjusting a height of the moulds relative the ground surface by placing a supporting material, penetratable by said spike, between a portion of at least one of the first and second mould and the ground surface.

16. The method of claim 13, further comprising the step of comprising the step of, prior to said step of further inserting said spike into said ground surface:
prior said step of snugly inserting of the spikes, placing a supporting material, penetratable by said spike, lengthwise underneath said moulds and alongside said moulds.

17. The method of claim 13, further comprising the step of:
adjusting the length of the connecting member by telescopically sliding first and second portions of the connecting member relative one another and locking said first and second portions in fixed position relative one another with a locking means connecting member.

18. The method of claim 14, further comprising the step of:
rotating at least one of said first and second spikes around respective rotation axes defined by respective bolts connecting said spikes to said connecting member into a desired angular inclination and locking said spike into said desired angular inclination relative said connecting member with a locking mechanism.

19. A brace for use in anchoring first and second moulds to one another and a ground surface during distribution of a cementitious material between respective inner walls of the moulds to form a cementitious structure extending on the ground surface between the moulds, each mould having at least one respective spike pathway disposed thereon, said brace comprising:
respective first and second spikes;
a connecting member, the connecting member connecting the spikes to one another at a fixed distance relative one another, each spike being insertable through one said spike pathway on each mould of each pair to anchor said moulds of each pair in fixed spatial relationship relative one another and from the spike pathways into the ground surface to anchor the moulds in said fixed spatial relationship to the ground surface for pouring of the cementitious material.

20. The brace of claim 19, further comprising:
first and second hollow pathway tubes connected to said connecting member, said spikes being snugly insertable through said pathway tubes to connect said spikes to said connecting member, said pathway tubes with said spikes inserted therethrough being snugly insertable through said pathways to insert said spikes through said pathways and into said ground surface.
